(19) United States
(12) Patent Application Publication
(10) Pub. No.: US 2026/0110643 A1
(43) Pub. Date: Apr. 23, 2026

(54) INSPECTION DEVICE FOR SIDE SURFACE OF CYLINDRICAL BATTERY

(71) Applicant: ENSCAPE CO., LTD., Yongin-si (KR)

(72) Inventors: Seong Gi KIM, Asan-si (KR); Ji Man RYU, Suwon-si (KR); Nam Dong KIM, Suwon-si (KR); Won Young JEONG, Suwon-si (KR)

(21) Appl. No.: 19/361,666

(22) Filed: Oct. 17, 2025

(30) Foreign Application Priority Data
Oct. 18, 2024 (KR) 10-2024-0142872
Dec. 30, 2024 (KR) 10-2024-0201246

(51) Int. Cl. G01N 21/952; G01N 21/84; G01N 21/88

(52) U.S. Cl. CPC G01N 21/952; G01N 21/8806; G01N 2021/845; G01N 2201/1053

(57) ABSTRACT

An inspection apparatus for the side surface of a cylindrical battery according to an embodiment of the disclosure includes a conveyor, an imaging case, an illumination unit located inside the imaging case and configured to emit light while the cylindrical battery product is conveyed along the conveyance path, a line scan camera module located outside the imaging case and configured to continuously capture images of the cylindrical battery product; and a mirror module configured to reflect a blind spot of the cylindrical battery product.

### CROSS REFERENCE TO RELATED APPLICATION

Priority to Korean Patent Applications No. 10-2024-0142872 filed on Oct. 18, 2024 and No. 10-2024-0201246 filed on Dec. 30, 2024, the entire disclosures of which are incorporated by reference herein, is claimed.

### BACKGROUND OF THE INVENTION

### Field of the Invention

The disclosure relates to an inspection apparatus for the side surface of a cylindrical battery. The present application is the result of the “materials and components technology development program (R&D)” supervised by the Korea Planning & Evaluation Institute of Industrial Technology (KEIT), under the project (titled “Development of an Integrated Optical System for Inspection and Measurement and AI-Based Vision Inspection System for Next-Generation Cylindrical Batteries (4680 to 46200 types), and Project No. RS-2024-00418621).

### Description of the Related Art

Secondary batteries refer to batteries that convert chemical energy into electrical energy to supply power and, when discharged, receive external power and convert electrical energy back into chemical energy for storage. With the advancement of electronic devices, the secondary batteries are being applied to various devices in a wide range of fields.

These secondary batteries are produced in a variety of forms, and among them, commonly used cylindrical batteries are still widely used today. The cylindrical secondary battery has a cylindrical structure with a curved side surface, and therefore a 360-degree rotational inspection is employed as a typical appearance inspection method.

Meanwhile, during the appearance inspection of the secondary battery, an area scan camera is generally used to capture images of the surface of the secondary battery. When using the area scan camera to capture images of the surface of the secondary battery, the cylindrical battery to be inspected needs to be temporarily stopped during conveyance to enable proper imaging. Furthermore, when the area scan camera is employed, it is necessary to appropriately adjust the installation position and specifications of an optical system according to the length of the cylindrical battery.

An aspect of the disclosure is to provide an inspection apparatus for the side surface of a cylindrical battery, in which the cylindrical battery is imaged while being conveyed without stopping.

Another aspect of the disclosure is to provide an inspection apparatus for the side surface of a cylindrical battery, in which side surface inspection is performed regardless of the length of the cylindrical battery.

The problems of the disclosure are not limited to the aforementioned problems, and other problems not mentioned above may become apparent to those skilled in the art from the following description.

### SUMMARY OF THE INVENTION

According to an embodiment of the disclosure, an inspection apparatus for a side surface of a cylindrical battery includes: a conveyor configured to convey a cylindrical battery product; an imaging case including a through opening formed allowing the cylindrical battery product conveyed by the conveyor to enter and exit an internal space thereof, and a slit formed perpendicularly to a conveyance path along which the cylindrical battery product passes through the internal space; an illumination unit located inside the imaging case and configured to emit light to the cylindrical battery product while the cylindrical battery product is conveyed along the conveyance path; a line scan camera module located outside the imaging case and configured to continuously capture images of the cylindrical battery product visible externally through the slit while the cylindrical battery product is conveyed along the conveyance path; and a mirror module located inside the internal space such that a reflective surface thereof is positioned to be visible externally through the slit and reflects a blind spot of the cylindrical battery product not visible through the slit.

The line scan camera module may capture images of both the cylindrical battery product visible through the slit and the reflective surface of the mirror module while the cylindrical battery product is conveyed along the conveyance path.

The mirror module may include a first mirror arranged with the reflective surface facing a first side of the cylindrical battery product, and a second mirror arranged with the reflective surface facing a second side of the cylindrical battery product.

The first mirror may include the reflective surface having a width corresponding to the slit and extending in a direction perpendicular to the conveyance path.

The mirror module may further include an angle adjustment actuator configured to adjust the angle of the first mirror with respect to the cylindrical battery product.

The mirror module may further include a horizontal drive unit configured to move the first mirror such that a distance between the first mirror and the conveyance path is adjusted.

The mirror module may further include a vertical drive unit configured to move the first mirror such that a distance between the first mirror and the slit is adjusted.

The line scan camera module may include: a main line scan camera angled to capture images of the cylindrical battery product visible through the slit; a first sub line scan camera angled to capture images of the reflective surface of the first mirror; and a second sub line scan camera angled to capture images of the reflective surface of the second mirror.

The inspection apparatus may further include a camera lifter configured to move the line scan camera module such that a distance between the line scan camera module and the slit is adjusted.

The imaging case may include a slit shutter movable between an open position where the slit is fully opened, and a closed position where the slit is fully blocked.

The imaging case may include an opening/closing shutter configured to operate synchronously with the illumination unit and open and close the through opening.

The inspection apparatus may further include an inverter configured to invert the cylindrical battery product that has passed the imaging case.

Other details of the disclosure are included in the detailed description and the accompanying drawings.

### BRIEF DESCRIPTION OF THE DRAWINGS

FIG. 1 is a schematic perspective view of an inspection apparatus for the side surface of a cylindrical battery according to an embodiment of the disclosure.

FIG. 2 is a schematic exploded perspective view of the main components of a first side inspection unit according to an embodiment of the disclosure.

FIG. 3 is a schematic view illustrating an illumination unit according to an embodiment of the disclosure.

FIG. 4 is a conceptual diagram illustrating a cylindrical battery product being imaged by a line scan camera module according to an embodiment of the disclosure.

FIG. 5 is a diagram illustrating portions of the cylindrical battery product imaged and not imaged in FIG. 4.

FIG. 6a is a diagram showing an open position of a slit shutter according to an embodiment of the disclosure.

FIG. 6b is a diagram showing an intermediate position of a slit shutter according to an embodiment of the disclosure.

FIG. 6c is a diagram showing a closed position of a slit shutter according to an embodiment of the disclosure.

FIG. 7a is a diagram showing an open state of an opening/closing shutter according to an embodiment of the disclosure.

FIG. 7b is a diagram showing a closed state of an opening/closing shutter according to an embodiment of the disclosure.

FIG. 8 is a diagram illustrating a cylindrical battery product being imaged by an inspection apparatus for the side surface of a cylindrical battery according to another embodiment of the disclosure, in a manner similar to FIG. 4.

### DETAILED DESCRIPTION OF THE INVENTION

The merits and characteristics of the disclosure and a method for achieving the merits and characteristics will become more apparent from embodiments described below in detail in conjunction with the accompanying drawings. However, the disclosure is not limited to the disclosed embodiments, but may be implemented in various different ways. The embodiments are provided to only complete the disclosure and to allow those skilled in the art to understand the category of the disclosure. The disclosure is defined by the category of the claims.

In addition, embodiments of the disclosure will be described with reference to cross-sectional views and/or schematic views as idealized exemplary illustrations. Therefore, the illustrations may be varied in shape depending on manufacturing techniques, tolerance, and/or etc. Further, elements in the drawings may be relatively enlarged or reduced for convenience of description. Like numerals refer to like elements throughout.

The term “cylindrical battery product” mentioned below may collectively refer to a finished cylindrical battery or a semi-finished product, such as a cylindrical battery can before jelly roll insertion.

Further, upper/lower/left/right/front/rear directions mentioned below are merely used to describe the disclosure with respect to a specific reference point, and the disclosure is not construed as being limited to such directions. In other words, it is apparent that, in actual use, the installation and use may be achieved in directions different from those set forth herein, and the disclosure should be interpreted as including such embodiments.

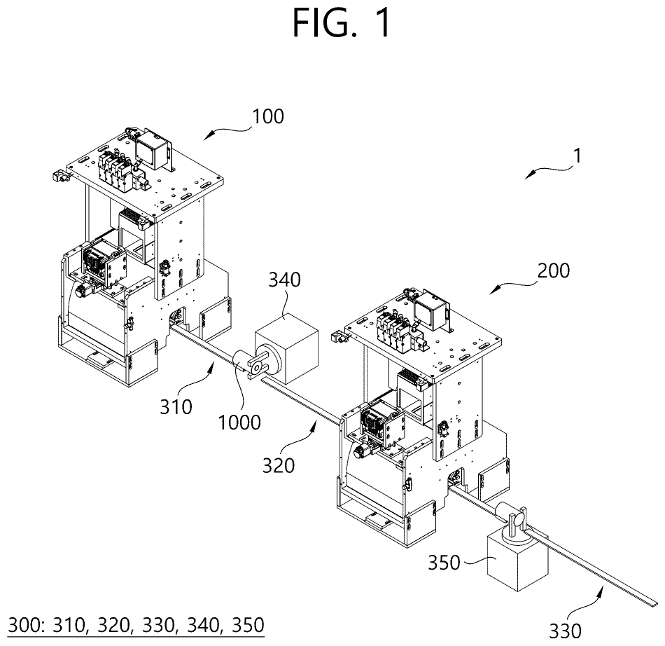

Below, an inspection apparatus 1 for the side surface of a cylindrical battery according to an embodiment of the disclosure will be described with reference to the accompanying drawings. FIG. 1 is a schematic perspective view of an inspection apparatus for the side surface of a cylindrical battery according to an embodiment of the disclosure.

As shown in FIG. 1, the inspection apparatus 1 for the side surface of a cylindrical battery according to an embodiment of the disclosure may include a first side inspection unit 100, a second side inspection unit 200, and a conveying unit 300. In this case, the first side inspection unit 100 and the second side inspection unit 200 may be substantially identical or similar. Therefore, to avoid redundancy, the following description will focus on the first side inspection unit 100, and redundant descriptions of the second side inspection unit 200 will be omitted.

Each of the first side inspection unit 100 and the second side inspection unit 200 may be configured to acquire images of an area of more than 180 degrees of the side surface of a cylindrical battery product 1000. To this end, the first side inspection unit 100 and the second side inspection unit 200 may include mirrors.

While passing through the interior of the first side inspection unit 100 and the interior of the second side inspection unit 200, the cylindrical battery product 1000 may be in a lying posture. In this case, the lying posture may refer to a state in which the side surface of the cylindrical battery faces downward and the circular top and bottom surfaces thereof face the front and rear directions, respectively. The first side inspection unit 100 and the second side inspection unit 200 may be configured to inspect opposite portions the side surface of the cylindrical battery product 1000 when the side surface is divided into two portions. In this case, to ensure that no portion of the side surface is missed during appearance inspection, the first side inspection unit 100 and the second side inspection unit 200 may each be configured to capture images of an area of more than half of the side surface. In this case, the areas inspected by the first side inspection unit 100 and the second side inspection unit 200 may partially overlap.

The cylindrical battery product 1000 that has passed through the first side inspection unit 100 in a first posture may be inverted from the first posture to a second posture by a first inverter 340 (to be described later), and then conveyed to the second side inspection unit 200. Thereafter, the cylindrical battery product 1000 undergoes inspection in the second side inspection unit 200 for an area that includes the remaining area not captured in the first side inspection unit 100.

The conveying unit 300 may be provided to convey the cylindrical battery product 1000. The conveying unit 300 may include a plurality of conveyors 310, 320 and 330 and a plurality of inverters 340 and 350. In this case, the plurality of conveyors 310, 320 and 330 may, in certain instances, be provided as a single conveyor 310, 320 or 330.

Each of the conveyors 310, 320 and 330 may include a rail and/or belt for conveying the cylindrical battery product 1000 mounted thereon in one direction. For example, the cylindrical battery product 1000 may be conveyed by the conveyors 310, 320 and 330 while mounted on a shuttle configured to convey the cylindrical battery product 1000. In another example, the cylindrical battery product 1000 may be conveyed while held by a seating device formed on the conveyors 310, 320 and 330. Although not shown, each of the conveyors 310, 320 and 330 may include a guard rail formed to prevent the cylindrical battery product 1000 from coming off during conveyance.

Hereinafter, the conveyors 310, 320 and 330 will be respectively referred to as a first conveyor 310, a second conveyor 320, and a third conveyor 330 according to paths they are in charge of. Furthermore, among the inverters 340 and 350, the inverter 340 located between the first conveyor 310 and the second conveyor 320 will be referred to as a first inverter 340, and the inverter 350 located between the second conveyor 320 and the third conveyor 330 will be referred to as a second inverter 350.

The first conveyor 310 may be configured to convey the cylindrical battery product 1000 to the first inverter 340 via the interior of the first side inspection unit 100. The second conveyor 320 may be configured to receive the cylindrical battery product 1000, the posture of which has been inverted, from the first invertor 340, and convey the received cylindrical battery product 1000 to the second inverter 350 via the interior of the second side inspection unit 200. The third conveyor 330 may be configured to receive the cylindrical battery product 1000 from the second inverter 350 and convey the received cylindrical battery product 1000 to an external inspection apparatus that inspects the cylindrical battery product in the subsequent order.

The first inverter 340 may be provided between the unit 100 and the second side inspection unit 200 and configured to change the posture of the cylindrical battery product 1000 so that the front and rear of the cylindrical battery product 1000 can be inverted relative to the previous state. For example, the first invertor 340 may be configured such that a conventionally known gripper holds a front end of the cylindrical battery product 1000, rotates by 180 degrees, and then releases the gripping state of the cylindrical battery product 1000. When the gripper releases its grip on the cylindrical battery product 1000, the cylindrical battery product 1000 may be seated on the second conveyor 320 located directly below. As a result, a surface of the cylindrical battery product 1000 that faced forward on the first conveyor 310 may face backward on the second conveyor 320. In this case, the gripper of the first invertor 340 may be positioned outside the cylindrical battery product 1000 in a width direction at the end of the first conveyor 310 and invert the cylindrical battery product 1000 about an axis parallel to the width direction.

The second inverter 350 may vertically rotate the cylindrical battery product 1000 so that the cylindrical battery product 1000 that has undergone the side surface inspection can have a posture for inspection of an upper and/or a lower surface. The second inverter 350 may be configured identically or similarly to the first inverter 340. In this case, unlike the first inverter 340, the gripper of the second inverter 350 may be positioned outside the cylindrical battery product 1000 in a height direction at the end of the second conveyor 320 and rotate the cylindrical battery product 1000 by 90 degrees about an axis parallel to the height direction.

Although not shown, the inspection apparatus 1 for the side surface of a cylindrical battery according to an embodiment of the disclosure may include an image processing unit that receives images acquired by the first side inspection unit 100 and/or the second side inspection unit 200. The image processing unit may be configured to process the acquired images, thereby determining whether a defect is present. For example, the image processing unit may be implemented as a program set to determine whether the presence or absence of a non-transitorily stored defect, a recording medium on which such a program is stored, or information processing device. The image processing unit may recognize defects present on the surface based on the captured images. Programs for recognizing defects based on images are already well-known and thus detailed descriptions thereof will be omitted. According to an embodiment of the disclosure, a plurality of inspection images may be acquired based on various lighting combinations of an illumination unit (to be described later), and the image processing unit may be programmed to determine defects in each of the inspection images and ultimately determine whether a detect is present.

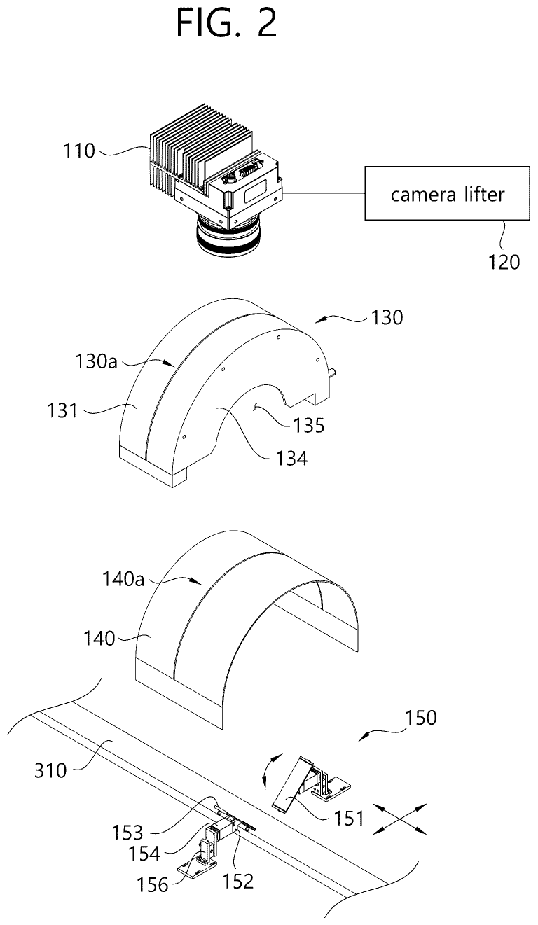

Hereinafter, a detailed configuration of the first side inspection unit 100 according to an embodiment of the disclosure will be described with reference to FIG. 2. FIG. 2 is a schematic exploded perspective view of the main components of a first side inspection unit according to an embodiment of the disclosure.

As shown in FIG. 2, the first side inspection unit 100 according to an embodiment of the disclosure may include a line scan camera module 110, an imaging case 130, an illumination unit 140, and a mirror module 150.

The line scan camera module 110 may be positioned outside the imaging case 130 and configured to continuously capture images of a cylindrical battery product while the cylindrical battery product moves along a conveyance path. The line scan camera module 110 may include a line scan camera that acquires an image of a subject as a line of pixels arranged in a straight line, and a frame for positioning the line scan camera inside the apparatus. The line scan camera module 110 may use an image sensor (charge coupled device (CCD), a complementary metal oxide semiconductor (CMOS), etc.) arranged in a linear form to continuously acquire pixel images of one line.

In this case, the line scan camera module 110 may capture the images of the cylindrical battery product, which is passing through the interior of the imaging case 130, from above the imaging case 130 through a slit 130a formed in the imaging case 130.

Meanwhile, the line scan camera module 110 may be provided to move up and down in the height direction by a camera lifter 120. The camera lifter 120 may use various conventional driving means capable of driving an object to reciprocate in a straight direction, and thus detailed descriptions thereof will be omitted. By the camera lifter 120, the line scan camera module 110 may adjust a relative straight-line distance from the cylindrical battery product according to various sizes of the cylindrical battery product. With this lifting operation, the line scan camera module 110 may properly focus on cylindrical battery products of different diameters (where the cylindrical battery product in the lying posture is varied in height depending on its diameter).

The imaging case 130 may be a roughly arch-shaped case that provides an internal space through which the cylindrical battery product conveyed by the conveyor 310 passes. The imaging case 130 may be configured to minimize the influence of external light while images of the cylindrical battery product 1000 located in the internal space are being captured. To function similarly to a darkroom, the imaging case 130 may be configured to minimize light entering from the outside. The imaging case 130 may include a side wall 131, an inlet wall, and an outlet wall 134.

The side wall 131 may be formed as a curved surface extending generally along the circumferential direction around an axis parallel to the longitudinal axis of the cylindrical battery product 1000 passing through the internal space. In this case, the internal space may refer to a space provided below the side wall 131 and surrounded by the side wall 131 at the lower side of the side wall 131. Furthermore, in this case, the conveyance path for the cylindrical battery product 1000 may be formed between the inlet wall and the outlet wall 134, and provided as a straight path parallel to the longitudinal direction of the cylindrical battery product 1000.

The slit 130a through which light can pass may be formed at the center on the top of the side wall 131. The slit 130a may extend in a direction perpendicular to the conveyance path of the cylindrical battery product 1000. Because the conveyance path is parallel to the longitudinal direction of the cylindrical battery product 1000, the slit 130a may be formed parallel to the width direction of the cylindrical battery product 1000.

The inlet wall is substantially flat and is configured to close the rear end of the side wall 131. The outlet wall 134 is substantially flat and configured symmetrically with the inlet wall so as to close the front end of the side wall 131. Here, the term “front” may refer to a direction in which the cylindrical battery product 1000 moves on the conveyance path. Meanwhile, the inlet wall and the outlet wall 134 may be formed with through openings 135 facing each other. The through openings 135 may be formed by cutting portions of the inlet wall and the outlet wall 134 located on the conveyance path.

Meanwhile, the conveyor 310 may be placed under the imaging case 130 along the conveyance path. The conveyor 310 may be positioned to pass through the inlet wall and the outlet wall 134 of the imaging case 130, and convey the cylindrical battery product 1000 along the conveyance path. In this case, the conveyor 310 may include a means for holding the cylindrical battery product 1000 in the lying posture, and convey the cylindrical battery product 1000 while holding it. Alternatively, the cylindrical battery product 1000 may be conveyed by the conveyor 310 while mounted on a dedicated shuttle. Here, the shuttle may be a case for conveying the cylindrical battery product 1000 without damage. For example, the shuttle may have a concave shape on its upper surface to accommodate the convex side of the cylindrical battery product 1000, thereby supporting the side surface of the cylindrical battery product 1000 thereon.

The illumination unit 140 may be mounted on the inner surface of the side wall 131 of the imaging case 130. In this case, the illumination unit 140 may include a plurality of lighting modules arranged at different positions in the front and rear directions. In addition, each lighting module may be configured to operate selectively. The illumination unit 140 may operate the plurality of lighting modules in various combinations. For example, all the lighting modules may operate according to a preset pattern or the lighting modules positioned being spaced apart from each other may operate independently.

Meanwhile, in order for the illumination unit 140 not to block the slit 130a, an area of the illumination unit 140 positioned directly below the slit 130a may be formed with an illumination slit 140a extending in the same direction as the slit 130a. The illumination slit 140a may be sized not to expose the illumination unit 140 to the outside through the slit 130a in the state that the illumination unit 140 is mounted on the inner surface of the side wall 131.

The mirror module 150 may have a reflective surface positioned to be visible from the outside through the illumination slit 140a and the slit 130a. The mirror module 150 may be set to reflect a blind spot in a lower portion of the cylindrical battery product 1000, which is not visible through the slit 130a, when the cylindrical battery product 1000 mounted on the conveyor 310 passes through the internal space. Therefore, the line scan camera module 110 can simultaneously capture both the portion of the cylindrical battery product 1000 facing the slit 130a and the portion illuminated by the mirror module 150. To this end, the width and length of the slit 130a and the illumination slit 140a may be at least large enough for the reflective surface of the mirror module 150 to be visible from the outside.

The mirror module 150 may include a first mirror 151, a second mirror 153, an angle adjustment actuator 152, a horizontal drive unit 154, and a vertical drive unit 156. In this case, the first mirror 151 and the second mirror 153 are installed symmetrically on the left and right sides with respect to the conveyor 310. Further, the angle adjustment actuator 152, the horizontal drive unit 154, and the vertical drive unit 156 may be provided for each of the first mirror 151 and the second mirror 153.

The first mirror 151 may be arranged to face a lower left portion of the cylindrical battery product 1000. The reflective surface of the first mirror 151 may face the lower left portion of the cylindrical battery product 1000 while being positioned directly below the slit 130a and the illumination slit 140a. The second mirror 153 may be arranged to face a lower right portion of the cylindrical battery product 1000. The reflective surface of the second mirror 153 may face the lower right portion of the cylindrical battery product 1000 while being positioned directly below the slit 130a and the illumination slit 140a.

The reflective surfaces of the first mirror 151 and the second mirror 153 may have a width corresponding to the slit 130a and extend in a direction perpendicular to the conveyance path. In this case, the width may be a length measured based on the conveying direction and/or the longitudinal direction.

The angle adjustment actuator 152 may be mounted on each of the first mirror 151 and the second mirror 153 to adjust the angle of the first mirror 151 or the second mirror 153 relative to the cylindrical battery product 1000. The angle adjustment actuator 152 may be connected to the opposite side of the reflective surface of the first mirror 151 or the second mirror 153, and may be implemented as various conventional means capable of rotating the first mirror 151 or the second mirror 153. In this case, the angle adjustment actuator 152 may adjust the angle of the first mirror 151 or the second mirror 153 around an axis parallel to the conveyance path. For example, the angle adjustment actuator 152 may include a motor, and an angle-adjustable frame powered by the motor.

The horizontal drive unit 154 may be based on various conventional linear motion drive means capable of moving the angle adjustment actuator 152 in the horizontal direction, thereby moving the first mirror 151 or the second mirror 153. For example, the horizontal drive unit 154 may include a motor and/or a hydraulic/pneumatic actuator, and a linearly movable frame powered by the same. The horizontal drive unit 154 may adjust a relative distance between the first mirror 151 or the second mirror 153 and the conveyance path. In other words, the first mirror 151 or the second mirror 153 may move along the width direction by the horizontal drive unit 154.

Similarly, the vertical drive unit 156 may be based on various conventional linear motion drive means capable of moving the horizontal drive unit 154 in the height direction, thereby moving the first mirror 151 or the second mirror 153. For example, the vertical drive unit 156 may include a motor and/or a hydraulic/pneumatic actuator, and a linearly movable frame powered by the same. The vertical drive unit 156 may adjust a relative height between the first mirror 151 or the second mirror 153 and the conveyance path. In other words, the first mirror 151 or the second mirror 153 may move along the height direction by the vertical drive unit 156.

In this case, the angle adjustment actuator 152, the horizontal drive unit 154 and the vertical drive unit 156 may be configured differently from the foregoing description. That is, the angle adjustment actuator 152, the horizontal drive unit 154 and the vertical drive unit 156 according to an embodiment of the disclosure are configured to adjust the angle, horizontal distance or height of the first mirror 151 or the second mirror 153, respectively, and are not limited to the configuration of any specific embodiment.

The reason why the mirror module 150 is configured to adjust the angles or positions of the first mirror 151 and the second mirror 153 may be to appropriately change the positions of the first mirror 151 and the second mirror 153 for the cylindrical battery product 1000 of various sizes.

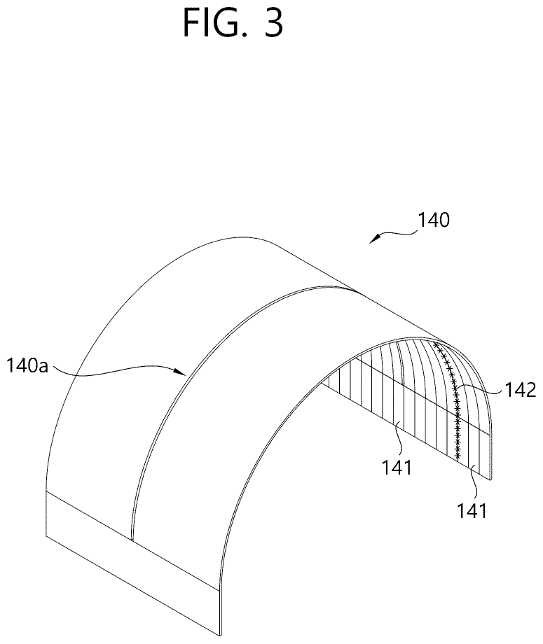

Hereinafter, the illumination unit 140 according to an embodiment of the disclosure will be further described with reference to FIG. 3. FIG. 3 is a schematic view illustrating an illumination unit according to an embodiment of the disclosure.

As shown in FIG. 3, the illumination unit 140 according to an embodiment of the disclosure may include multiple rows of light-emitting modules arranged on the internal surface in the front and back directions. Each row of light-emitting modules is arranged in an arch shape along the inner wall of the illumination unit, and each row is configured to operate independently. In this case, a controller may select a light-emitting module 142 to operate and a light-emitting module 141 not to operate.

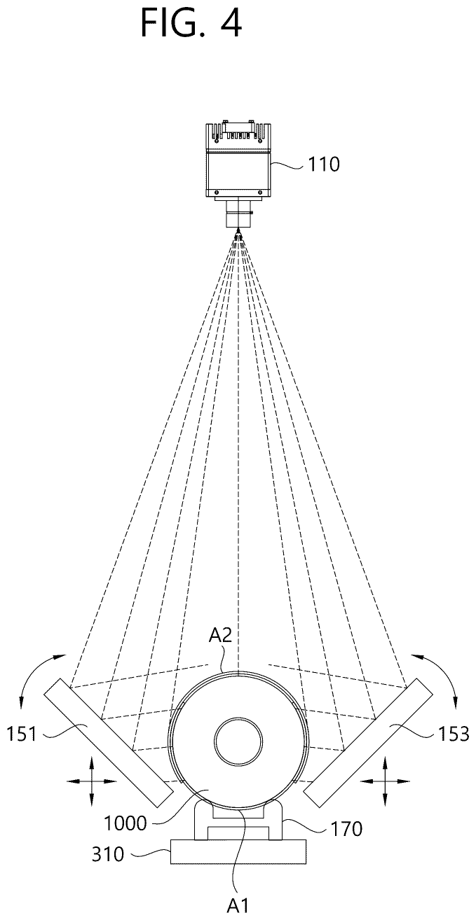

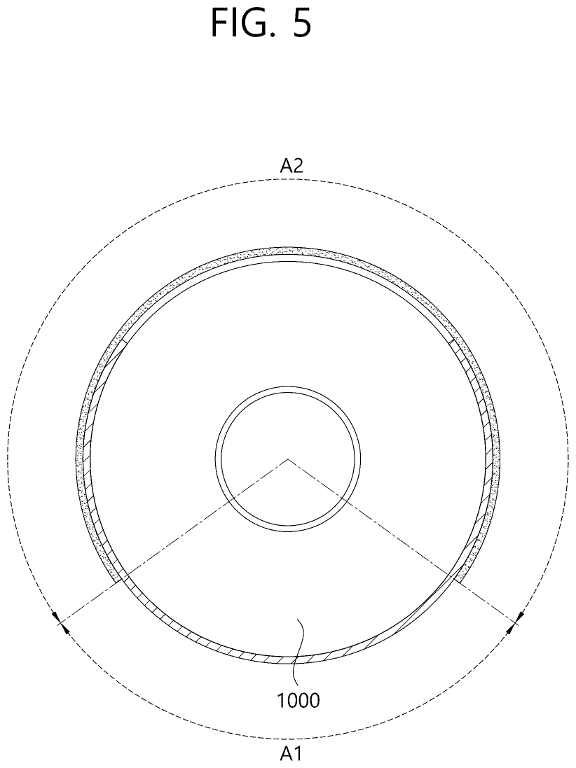

Hereinafter, a portion of the cylindrical battery product 1000 to be imaged by the line scan camera module 110 according to an embodiment of the disclosure will be described with reference to FIGS. 4 and 5. FIG. 4 is a conceptual diagram illustrating a cylindrical battery product being imaged by a line scan camera module according to an embodiment of the disclosure. In this regard, FIG. 5 is a diagram illustrating portions of the cylindrical battery product imaged and not imaged in FIG. 4.

Referring to FIG. 4, the line scan camera module 110 may be configured to adjust the focus, and may be configured to adjust a focal length based on difference between an optical path of when capturing the image of the cylindrical battery product 1000 directly and an optical path of when capturing the image of the cylindrical battery product 1000 via the first mirror 151 and/or the second mirror 153. Meanwhile, an object 170 positioned on the conveyor 310 in FIG. 4 serves as a transport unit 170 for transporting the cylindrical battery product 1000, and may be the aforementioned shuttle or a holding device provided on the conveyor 310.

Referring to FIGS. 4 and 5 together with FIG. 2, when the line scan camera module 110 captures images of the internal space through the slit 130a, an arc portion A2 of the cylindrical battery product 1000, which has a central angle of 180 degrees or more and is observed through the slit 130a may be imaged. In this case, the arc portion A2 may refer to a portion of the cylindrical battery product 1000 in the lying posture, which includes the circumference of an upper portion facing the ceiling of the imaging case 130. The center portion of the arc A2 may be imaged directly by the line scan camera module 110. On the other hand, both end portions of the arc A2 positioned approximately perpendicular to the line scan camera module 110 may be imaged indirectly based on reflections on the first mirror 151 and the second mirror 153, respectively.

In this case, the width of the transport unit 170 may be determined to correspond to an area of 150 degrees or less of the circumference of the cylindrical battery product 1000 so as not to interfere with the optical path of the line scan camera module 110 when capturing images of the first mirror 151 and the second mirror 153. Accordingly, the transport unit 170 does not appear in the images captured by the line scan camera module 110.

Meanwhile, the circumference A1 located in a blind spot facing the transport unit 170 and/or the conveyor 310 may not be captured by the first side inspection unit 100. This portion A1 may be captured by the second side inspection unit 200 after changing the posture of the cylindrical battery product 1000.

According to an embodiment of the disclosure, while the cylindrical battery product 1000 moves along a conveyance path, the line scan camera module 110 may continuously capture images of the area A2 exposed through the slit 130a. Thus, when the cylindrical battery product 1000 passes through the first side inspection unit 100, an image of the area of the cylindrical battery product 1000 formed by connecting the arcs A2 exposed through the slit 130a may be acquired. For example, the image initially acquired by the line scan camera module 110 may be a two-dimensional planar image of the cylindrical battery product 1000, in which the area directly captured by the line scan camera module 110 is positioned at the center and the areas captured based on the reflections on the mirrors 151 and 153 are positioned on either side. The method of acquiring an image of a surface with multiple pixel lines is the same or similar to the conventional method of using a line scan camera, and thus descriptions thereof will be omitted.

The first side inspection unit 100 may transmit the captured image to an external data processing device.

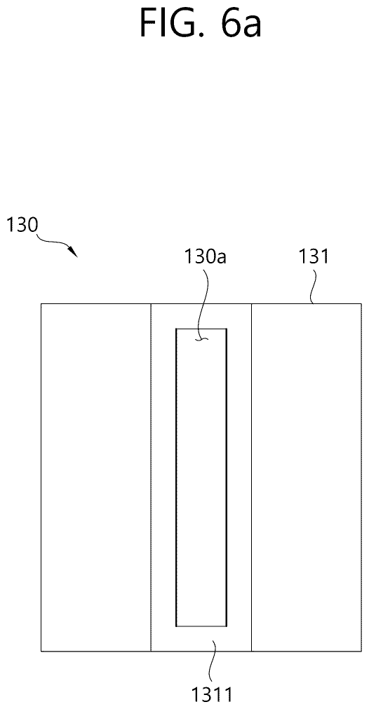

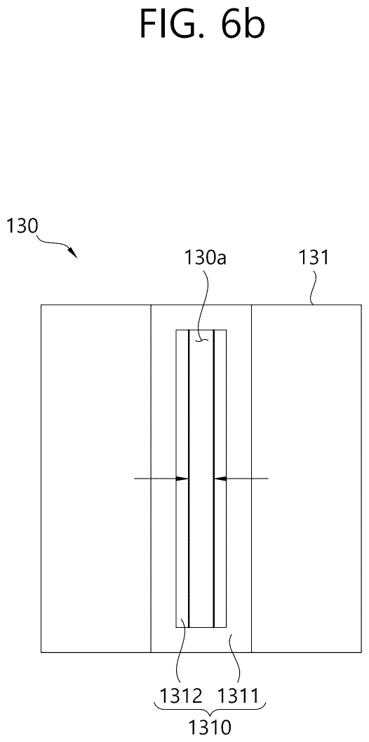

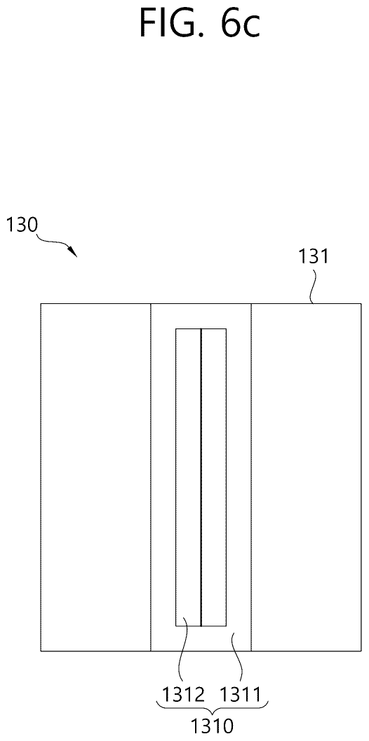

Hereinafter, a slit shutter 1310 according to an embodiment of the disclosure will be described with reference to FIGS. 6a to 6c.

FIG. 6a is a diagram showing an open position of a slit shutter according to an embodiment of the disclosure. On the other hand, FIG. 6b is a diagram showing an intermediate position of a slit shutter according to an embodiment of the disclosure. Further, FIG. 6c is a diagram showing a closed position of a slit shutter according to an embodiment of the disclosure. In this case, FIGS. 6a to 6c conceptually show the side wall 131 and the slit shutter 1310 of the imaging case 130 when viewed from above.

Referring to FIGS. 6a to 6c, according to an embodiment of the disclosure, the slit shutter 1310 may be additionally installed in the side wall 131. The slit shutter 1310 is movable between the open position and the closed position, thereby fully opening the slit 130a in the open position and fully covering the slit 130a in the closed position. In this case, the intermediate position may be a position between the open position and the closed position. When the slit shutter 1310 is installed, there is an advantage in that the slit 130a can be formed to have a wide width and then the width can be adjusted as needed.

The slit shutter 1310 may include a shutter housing 1311 installed on the side wall 131, and a symmetrical drive gate 1312 driven inside the shutter housing 1311. The shutter housing 1311 may be formed with an opening, through which the slit 130a is exposed, at the center, and may be mounted on the side wall 131 such that the opening can be positioned above the slit 130a.

The symmetrical drive gate 1312 is embedded in the shutter housing 1311, and serves as a gate that opens and closes. The symmetrical drive gat4e 1312 may be connected to a driving means (e.g., a motor, an actuator, etc.) for the opening and closing operation. The symmetrical drive gate 1312 may include two plate-shaped members symmetrically arranged within the shutter housing 1311. The two plate-shaped members operate symmetrically so that the areas where the two plate-shaped members block the slit 130a can be equal or similar to each other.

In this case, as shown in FIG. 6a, the two plate-shaped members of the symmetrical drive gate 1312 may be fully accommodated within the shutter housing 1311 in the open position. As shown in FIG. 6b, when the symmetrical driving gate 1312 is moved to the intermediate position, the two plate-shaped members may approach each other by the same or similar distance. Therefore, the central axis of the slit 130a exposed between the symmetrical drive gates 1312 can always be constant. When the symmetrical drive gates 1312 are fully close to each other, the state shown in FIG. 6c may be achieved. However, FIG. 6c is merely exemplary, and the slit 130a may not be completely blocked even when the symmetrical driving gates 1312 are moved to the fully closed position.

The width-adjustable structure of the slit 130a by the slit shutter 1310 may correspond to the vertical movement of the line scan camera module. That is, the slit shutter 1310 may function to adjust the width of the slit 130a by taking into account the angle of view that varies depending on the height variation of the line scan camera module.

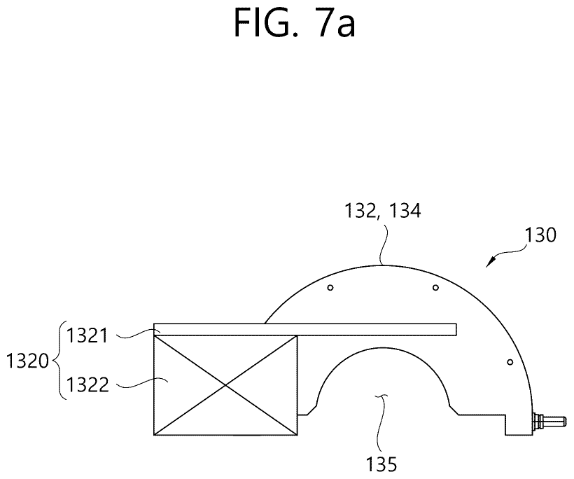

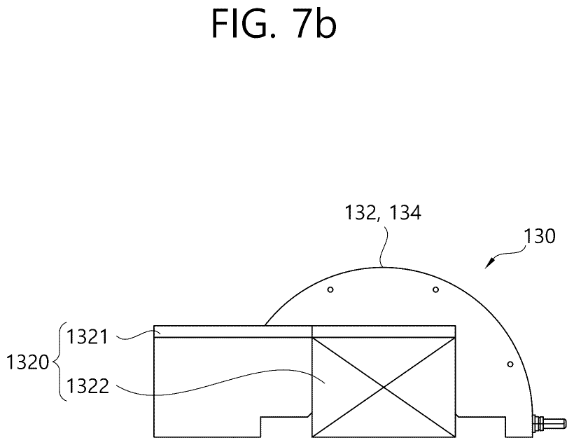

Hereinafter, an opening/closing shutter 1320 according to an embodiment of the disclosure will be described with reference to FIGS. 7a and 7b. FIG. 7a is a diagram showing an open state of an opening/closing shutter according to an embodiment of the disclosure. On the other hand, FIG. 7b is a diagram showing a closed state of an opening/closing shutter according to an embodiment of the disclosure.

As shown in FIGS. 7a and 7b, an opening/closing shutter 1320 according to an embodiment of the disclosure may be installed in an inlet wall 132 and/or an outlet wall 134 and operated to open/close the through opening 135.

The opening/closing shutter 1320 may include a guide rail 1321 and a movable plate 1322. The guide rail 1321 may be coupled to the inlet wall 132 and/or the outlet wall 134 so as to be positioned above the through opening 135. Further, the guide rail 1321 may extend linearly so that the movable plate 1322 can operate between the closed position and the open position.

The movable plate 1322 may be coupled to the guide rail 1321 so as to slide along the extending direction of the guide rail 1321. The movable plate 1322 may be powered by a motor or the like means to slide between one end of the guide rail 1321 and the other end. In this case, as shown in FIG. 7a, when the movable plate 1322 is brought into close contact with one end of the guide rail 1321 located far from the through opening 135, the opening/closing shutter 1320 may be opened. On the other hand, as shown in FIG. 7b, when the movable plate 1322 is brought into close contact with the other end of the guide rail 1321 located adjacent to the through opening 135, the opening/closing shutter 1320 may be closed. In the closed state of the opening/closing shutter 1320, the through opening 135 may be blocked by the body of the movable plate 1322, thereby separating the internal space and the external space of the imaging case 130.

Meanwhile, the movable plate 1322 may be controlled by the controller that controls the illumination unit (140; see FIG. 3) so as to operate synchronously with the illumination unit 140. In this case, the control for the movable plate 1322 to operate synchronously with the illumination unit 140 may mean that the movable plate 1322 is controlled to move to the closed position just before the illumination unit 140 operates to make the first light-emitting module 141, 142 emit light, and the movable plate 1322 is controlled to move to the open position just after the light-emission of all the light-emitting modules 141, 142 is completed.

Such operations of the opening/closing shutter 1320 may have an effect on minimizing the influence of external light during the imaging process performed by the illumination unit 140.

According to an embodiment of the disclosure, the inspection apparatus for the side surface of a cylindrical battery performs inspection while continuously capturing images of the side surface of a cylindrical battery product without stopping the one-directional conveying operation, thereby having an advantage of minimizing the time required to inspect a single product. Furthermore, according to an embodiment of the disclosure, the inspection apparatus for the side surface of a cylindrical battery employs the line scan camera for maximizing an imaging efficiency for a moving object as well as shortening the inspection time, thereby ensuring high-resolution images even while the object is continuously moving.

In particular, according to an embodiment of the disclosure, the inspection apparatus for the side surface of a cylindrical battery continuously captures images of a cylindrical battery product while the cylindrical battery product moves in one direction, thereby having an advantage of being unaffected by the length of the length of the cylindrical battery product. For example, according to the disclosure, it is possible to scan and inspect the side surface of a cylindrical battery product even in an extreme case where the cylindrical battery product in the lying posture is longer than the imaging case.

Further, according to an embodiment of the disclosure, the inspection apparatus for the side surface of a cylindrical battery minimizes the influence of external light by minimizing the width of the slit. Furthermore, according to an embodiment of the disclosure, the inspection apparatus for the side surface of a cylindrical battery has an advantage of reducing the cost of the mirror because the mirror only needs to correspond to the width of the slit.

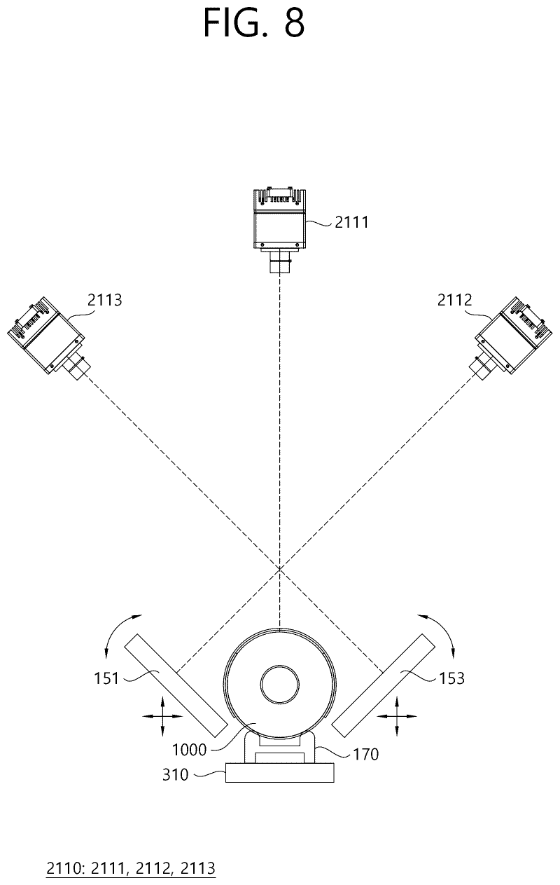

Hereinafter, based on the foregoing description, an inspection apparatus for the side surface of a cylindrical battery according to another embodiment of the disclosure will be described with reference to FIG. 8. To avoid redundant descriptions, the same content as in the previous embodiment will be omitted, and descriptions will be made focusing the differences from the previous embodiment. FIG. 8 is a diagram illustrating a cylindrical battery product being imaged by an inspection apparatus for the side surface of a cylindrical battery according to another embodiment of the disclosure, in a manner similar to FIG. 4.

Unlike the aforementioned embodiment, a line scan camera module 2110 according to this embodiment may include a plurality of line scan cameras. In more detail, the line scan camera module 2110 may include one main line scan camera 2111 and two sub line scan cameras 2112 and 2113.

Unlike the foregoing line scan camera, the main line scan camera 2111 may be set to focus primarily on a portion to be directly imaged through the slit 130a (see FIG. 2), rather than being set to clearly capture even the portion based on the reflections of the first mirror 151 or the second mirror 153. That is, the main line scan camera 2111 may be set to focus primarily on the portions of the imaging area A2 that are directly exposed through the slit 130a. Similarly to the aforementioned embodiment, the main line scan camera 2111 may be configured to be vertically adjustable in position.

The sub line scan cameras 2112 and 2113 may include a first sub-line scan camera 2112, which is angled to primarily capture the reflective surface of the first mirror 151, and a second sub-line scan camera 2113, which is angled to primarily capture the reflective surface of the second mirror 153. The focus of the first sub-line scan camera 2112 may be set to clearly capture a reflection on the reflective surface of the first mirror 151, and the focus of the second sub-line scan camera 2113 may be set to clearly capture a reflection on the reflective surface of the second mirror 153.

To this end, the sub line scan cameras 2112 and 2113 may be adjustable in vertical height as well as viewing angle and horizontal distance. For example, each of the sub line scan cameras 2112 and 2113 may be adjusted to have an optical axis that is approximately perpendicular to the surface of the corresponding mirrors 151 and 153. In this case, the means for adjusting the height/horizontal distance of the main line scan camera 2111 and the sub line scan cameras 2112 and 2113 and the means for adjusting the angle of the sub line scan cameras 2112 and 2113 may be implemented by various conventionally known means, and thus detailed descriptions thereof will be omitted.

A person having ordinary knowledge in the art to which the disclosure pertains can understood that the disclosure may be embodied in other specific forms without changing technical spirit or essential features. Accordingly, the embodiments described above are illustrative and not restrictive in all aspects. The scope of the disclosure is defined by the appended claims rather than the foregoing detailed description, and all changes or modifications derived from the meaning and scope of the appended claims and their equivalents are construed as falling within the scope of the disclosure.

According to the embodiments of the disclosure, the effects are at least as follows.

Compared to the area scan method, the number of optical system installation points relative to the total battery production volume can be reduced.

The side surface of a cylindrical battery can be completely inspected within a minimized time.

Compatibility can be achieved with cylindrical batteries of various sizes.

When inspecting the side surface of the cylindrical battery, improved inspection accuracy can be achieved based on the good MTF of the line scan camera.

During the inspection of the side surface of the cylindrical battery, inspection accuracy can be improved based on the good modulation transfer function (MTF) of the line scan camera.

The effects of the disclosure are not limited to those described above, and various other effects are included in the foregoing description.

[Reference Numerals]

| | |
|---|---|
| 1: inspection apparatus for side | |
| surface of cylindrical battery | |
| 100: first side inspection unit | |
| 110, 2110: line scan camera module | |
| 120: camera lifter | 130: imaging case |
| 130a: slit | 131: side wall |
| 132: inlet wall | 134: outlet wall |
| 135: through opening | 140: illumination unit |
| 140a: illumination slit | 150: mirror module |
| 151, 153: mirror | |
| 152: angle adjustment actuator | |
| 154: horizontal drive unit | 156: vertical drive unit |
| 170: transport unit | |
| 200: second side inspection unit | |
| 300: conveying unit | 310, 320, 330: conveyor |
| 340, 350: inverter | |
| 1000: cylindrical battery product | |
| 1310: slit shutter | 1311: shutter housing |
| 1312: symmetric drive gate | |
| 1320: opening/closing shutter | |
| 1321: guide rail | 1322: movable plate |
| 2111: main line scan camera | |
| 2112, 2113: sub line scan camera | |

What is claimed is:

1. An inspection apparatus for a side surface of a cylindrical battery, the inspection apparatus comprising:
a conveyor configured to convey a cylindrical battery product;
an imaging case comprising a through opening formed allowing the cylindrical battery product conveyed by the conveyor to enter and exit an internal space thereof, and a slit formed perpendicularly to a conveyance path along which the cylindrical battery product passes through the internal space;
an illumination unit located inside the imaging case and configured to emit light to the cylindrical battery product while the cylindrical battery product is conveyed along the conveyance path;
a line scan camera module located outside the imaging case and configured to continuously capture images of the cylindrical battery product visible externally through the slit while the cylindrical battery product is conveyed along the conveyance path; and
a mirror module located inside the internal space such that a reflective surface thereof is positioned to be visible externally through the slit and the reflective surface reflects a blind spot of the cylindrical battery product not visible through the slit, wherein
the line scan camera module captures images of both the cylindrical battery product visible through the slit and the reflective surface of the mirror module while the cylindrical battery product is conveyed along the conveyance path.

2. The inspection apparatus of claim 1, wherein the mirror module comprises a first mirror arranged with the reflective surface facing a first side of the cylindrical battery product, and a second mirror arranged with the reflective surface facing a second side of the cylindrical battery product.

3. The inspection apparatus of claim 2, wherein the first mirror comprises the reflective surface having a width corresponding to the slit and extending in a direction perpendicular to the conveyance path.

4. The inspection apparatus of claim 2, wherein the mirror module further comprises an angle adjustment actuator configured to adjust the angle of the first mirror with respect to the cylindrical battery product.

5. The inspection apparatus of claim 4, wherein the mirror module further comprises a horizontal drive unit configured to move the first mirror such that a distance between the first mirror and the conveyance path is adjusted.

6. The inspection apparatus of claim 4, wherein the mirror module further comprises a vertical drive unit configured to move the first mirror such that a distance between the first mirror and the slit is adjusted.

7. The inspection apparatus of claim 2, wherein the line scan camera module comprises:
a main line scan camera angled to capture images of the cylindrical battery product visible through the slit;
a first sub line scan camera angled to capture images of the reflective surface of the first mirror; and
a second sub line scan camera angled to capture images of the reflective surface of the second mirror.

8. The inspection apparatus of claim 1, further comprising a camera lifter configured to move the line scan camera module such that a distance between the line scan camera module and the slit is adjusted.

9. The inspection apparatus of claim 8, wherein the imaging case comprises a slit shutter movable between an open position where the slit is fully opened, and a closed position where the slit is fully blocked.

10. The inspection apparatus of claim 1, wherein the imaging case comprises an opening/closing shutter configured to operate synchronously with the illumination unit and open and close the through opening.

11. The inspection apparatus of claim 1, further comprising an inverter configured to invert the cylindrical battery product that has passed the imaging case.
